(19) United States
(12) Patent Application Publication
(10) Pub. No.: US 2007/0248766 A1
(43) Pub. Date: Oct. 25, 2007

(54) Method And Apparatus For Thermal Spray Coating

(76) Inventor: Vladimir BELASHCHENKO, Concord, NH (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 11/676,163

(22) Filed: Feb. 16, 2007

Related U.S. Application Data
(63) Continuation of application No. PCT/US05/28997, filed on Aug. 15, 2005.
(60) Provisional application No. 60/602,253, filed on Aug. 17, 2004.

(51) Int. Cl. B05C 5/00

(52) U.S. Cl. 427/446; 118/312

(57) ABSTRACT

A method of supplying a coating to a substrate by spraying heated particles of a coating material onto the substrate. The particles are heated to a temperature and sprayed at a velocity such that the total energy of the particles is less than the energy necessary to melt the particles. When the particles collide with the substrate the particles may plastically deform to a diameter with the substrate that is greater than the diameter of the particle prior to colliding with the substrate. The deformed particle may bond to the substrate about the majority of the deformed diameter of the particle.

### CROSS REFERENCE TO RELATED APPLICATIONS

This application is a continuation of International Application No. PCT/US2005/028997 filed Aug. 15, 2005 and published Mar. 2, 2006 as International Publication No. WO 2006/023450, designating the United States, and which claims benefit of the filing date of U.S. Provisional Application Ser. No. 60/602,253 filed Aug. 17, 2004, the teachings of which are incorporated herein by reference.

### FIELD

The present disclosure is directed at a method and apparatus for thermal spray coating.

### BACKGROUND

High velocity spraying processes based on combustion of oxygen-fuel mixtures (HVOF) or air-fuel mixtures (HVAF) allow coatings to be sprayed from variety of materials. HVOF and HVAF processes may generally produce sonic and supersonic gas jets including combustion products of the oxygen-fuel or air-fuel mixtures. High quality coatings can be sprayed at a high level of efficiency when the temperature of the combustion products is high enough to soften or melt the particles being sprayed and the velocity of the stream of combustion products is high enough to provide the required density and other coating properties. Different materials require different optimum temperatures of the sprayed particles in order to provide an efficient formation of high quality coatings. Higher melting point materials, such as cobalt and/or nickel based alloys, carbides and composite materials, may often require relatively high temperatures in order to soften the particles to a level sufficient to efficiently form high quality coatings.

Some of the parameters affecting the available range of temperatures and velocities available from the combustion products are combustion pressure, types of fuel and oxidizer and ratio of fuel/oxidizer flow rates. Commonly used fuels may include gaseous and liquid hydrocarbon fuels like propane, propylene, MAPP gas, kerosene. Hydrogen may also be used as a fuel. Liquid fuels may provide some advantages over gaseous fuels. The use of liquid fuels may be less expensive than gaseous fuels and may be more easily fed into combustion apparatus at high pressure by using pumps or pressurized tanks. Some of gaseous fuels, for example, propane, are supplied in tanks at relatively low pressure. A tank of a gaseous fuel at low pressure may require pre-heating in order to provide a spraying gun with high pressure gaseous fuel. The pre-heating is not attractive from safety standpoint.

Combustion devices and other parts of combustion apparatus may require cooling because of high temperatures of combustion. Cooling, however, may result in heat losses from the combustion apparatus to the cooling media. This heat loss may be a factor that can affect the efficiency of the process, for example by influencing the temperature and velocity of a combustion jet. Heat losses may depend, at least in part, on the intensity of the cooling and the surface areas of the combustion apparatus that are being cooled by a cooling media.

According to some designs, compressed air or oxygen is fed through air passages surrounding the combustion chamber and the barrel/nozzle assembly in order to cool these parts. The compressed air is then fed from the passages into the combustion chamber and is used as an air supply for the combustion process. This “regenerative” heat exchange may be economical and may reduce heat losses from the combustion. Oxygen has a relatively low flow rate in comparison with air. Therefore, cooling using only oxygen may not be sufficient to prevent an HVOF system, which may generally operate at a higher temperature than an HVAF system, from overheating.

Oxygen/fuel mixtures may achieve high combustion temperatures, in some cases reaching temperatures of 3000 degrees C. or higher. To protect the apparatus from damage due to these extreme temperatures, water is commonly used as a cooling media for oxygen/fuel mixtures. In addition to the use of water cooling systems, combustion chambers for burning oxygen/fuel mixtures, as well as other components that will be exposed to high temperatures, are often manufactured from copper or copper alloys. Very efficient cooling may be achieved using water as a cooling medium in combination with copper or copper alloy components. Unfortunately, such efficient cooling may result in relatively large heat losses, especially in combustion systems having large internal surface areas and/or numerous turns in the path of combustion products.

Thermal spray coating typically follows one of several general schemes. According to a first method, particles to be coated on to a substrate may be heated so that the temperature of the particle when it contacts the substrate is greater than the melting temperature for the particle material. Because the particle is in a molten or fused state and traveling at a relatively high velocity when it contacts the substrate, splashing of the molten or fused particle often occurs during the collision and interaction with the substrate. As shown in FIG. 9, splashing often results in voids and excessive surface area of the splashed particle. These characteristics may, consequently, result in excessive oxidation. As shown in FIG. 9, a normal component of pressure may exist only on a surface area underneath a particle and having diameter Dx which is equal or smaller than diameter Dp of the sprayed particle. In this case good bonding may only develop in the area with diameter Dx underneath the particle. The splashed part of the particle, i.e., the portion outside the diameter Dx, may not have a proper contact with a substrate to enable good bonding to the substrate. Higher impact velocities may result in the higher intensity of the splashing and a greater area of the particle extending outside of the diameter Dx. Particles applied according to this scheme may exhibit a level of flattening, characterized by δ=D/Dp where D is the splat diameter and Dp is the initial particle diameter, the range of about 2.6-4.

According to a second scheme, thermal spraying may take place under conditions such that CpTp+Vp²/2>CpTm+Lm; where Cp is the average thermal capacity of the sprayed material; Tp is the temperature of the particle at contact with the substrate; Vp is the velocity of the particle at contact with the substrate, Lm is the latent heat of melting of the spraying material; and Tm is the melting temperature. Such a scheme is often termed “impact fusion”. While the intensity of splashing may be lower than experienced in the first spraying scheme, splashing of the coating particles is generally experienced during impact fusion. Splashing that occurs during impact fusion results in all of the same consequences discussed above.

According to a third coating scheme particles may be heated to a temperature sufficiently low to prevent thermal softening of sprayed particles. The particle heated in this manner may be applied to a substrate at high velocities. This coating scheme may generally only be applicable to use with coating materials having very low yield stress, for example in a general range of about 200 MPa or less.

### BRIEF DESCRIPTION OF THE DRAWINGS

Features and advantages of the method and apparatus of the present disclosure will be apparent from the following description of embodiments consistent therewith, which description should be considered in conjunction with the accompanying drawing, wherein:

FIG. 1 is a schematic illustration of the an embodiment of an HVTS apparatus consistent with the present disclosure;

FIG. 2 is an illustration of the rectangular forming block

FIG. 3 is a general schematic illustration of an embodiment of a cascade plasma torch;

FIG. 4 illustrates a stepped anode that may be employed in a plasma torch consistent with the preset disclosure;

FIG. 5 illustrates an embodiment of a plasma forming module of a plasma torch that is electrically insulated from the anode;

FIG. 6 illustrates an embodiment of a mixing chamber and a forming module with an axial powder feeding;

FIG. 7 illustrates an embodiment of a mixing chamber and a forming module with and axial powder feeding and a passage connected with a vacuum pump;

FIG. 8 illustrates an embodiment of a mixing chamber and a forming module with the attached barrel and radial powder feeding in a low pressure zone;

FIG. 9 is a schematic illustration of a molten particle interaction with a substrate; and

FIG. 10 is a schematic illustration of a particle interaction with a substrate in accordance with the present disclosure.

### DESCRIPTION

As an overview, the present disclosure may generally provide a high velocity thermal spray (HVTS) apparatus. The apparatus may generally provide a stream of gas having a desired temperature and velocity profile. The apparatus may additionally allow a powder or particulate material to be introduced into the gas stream. The apparatus may be used for applications such as thermal spray coating, shot peening, etc.

According to an embodiment herein, the HVTS apparatus may be provided including a first module providing a heating module that may provide high temperature gases at pressure Pcc. In one embodiment, the gas pressure Pcc in the heating module may be between about 3-4 times, or more, greater than ambient pressure. The gas at the outlet of the heating module may have a temperature Tcc.

A second module of the HVTS apparatus may be configured as a mixing module to combine high temperature gas generated by the heating module with lower temperature compressed gas. Combining the high temperature gas from the heating module with compressed gas may allow the temperature of the gas stream to be controlled and/or adjusted to a desired or predetermined temperature.

A third module of the HVTS apparatus may be configured as a forming module which may form the stream of gasses from the mixing module. That is, the forming module may control the pressure and/or velocity profiles of the gases from the mixing module. According to one embodiment the forming module may accelerate the gases from the mixing module to provide a sonic or supersonic jet of gas.

A fourth module may include a powder feeding module which may feed a powder to be sprayed by the HVTS apparatus into the gas stream produced in the mixing module and/or combustion and mixing modules. The powder introduced in the feeding module may be sprayed onto a substrate to form a coating, to shot peen the substrate or a coating thereon, etc.

The modular design approach of the HVTS apparatus may allow separate modules to be provided having desired performance characteristics. The separate modules may be assembled to provide desired performance parameters for the HVTS apparatus as a whole. The separate modules may be provided, for example, to provide a desired performance for use with a particular heating module design, spraying materials and/or requirement of coatings to be sprayed. Thus the system may provide different modules allowing a desired performance to be achieved for different conditions. According to one embodiment, the heating module of HVTS apparatus may be provided as an oxidizer-fuel combustion module. According to another embodiment, the heating module of HVTS apparatus may be provided as a plasma torch. According to yet another embodiment, the heating module of HVTS apparatus may be provided as a resistance heater. Other configurations may also may achieved consistent with the present disclosure.

According to one embodiment consistent with the present disclosure, it may be desirable to operate the heating and mixing modules at a pressure Pcc which is in the range of about 5-6 times, or more, greater than an ambient pressure. In yet another embodiment it may be desirable to operate heating and mixing modules at a pressure Pcc which is in the range of about 9-10 times, or more, greater than an ambient pressure. In yet another embodiment it may be desirable to operate heating and mixing modules at a pressure Pcc which is in the range of about 14-15 times, or more, greater than an ambient pressure. Such operating pressure Pcc may allow coating particles to be accelerated up to a velocity that may approach, or even exceed, about 1000 m/s. The exact velocity achieved by the coating particles may vary greatly, however, depending upon the pressure, gas temperature, particle size, etc. Accordingly, the velocity experienced by coating particles may range from the range of hundreds of meters per second and up.

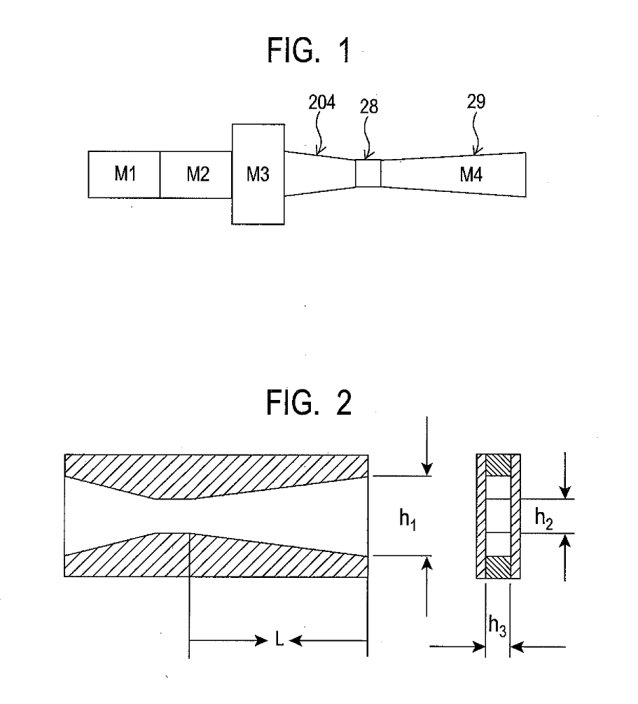

Referring to FIG. 1, an HVTS apparatus 100 is schematically illustrated including a heating module M1, a mixing module M2, a forming module M4, a powder feeding module M3. While an apparatus herein may generally be referred to as an HVTS apparatus, the apparatus may be configured as a HVOF (high velocity oxidizer-fuel) apparatus, a high velocity high pressure plasma apparatus, and/or similar systems producing an output including a stream of heated gaseous products. While the HVTS apparatus 100 is schematically delineated in to four modules M1, M2, M3, M4 the HVTS apparatus 100 may include additional features or modules. Additionally, it is not necessary within the present disclosure that the four modules M1, M2, M3, M4 are physically discrete or separable components. For example, the powder feeding module M3 may be provided as a part of the forming module M4 or may be disposed within the forming module. Moreover, the various modules M1, M2, M3, M4 may be disposed in a different arrangement relative to one another. For example, in an embodiment in which the powder feeding module M3 is not provided as part of, or integrated with, the forming module, the powder feeding module may be disposed downstream of the forming module M4, rather than upstream of the forming module M4 such as shown in FIG. 1.

The forming module M4 may include a converging zone 204 in which the diameter of the gas passage is reduced. The converging zone 204 may terminate in a throat or orifice 28. From the throat 28, the diameter of the gas passage may increase through an expansion zone 29. The increasing diameter of the gas passage in the expansion zone 29 may cause the stream of gas may accelerate.

As mentioned above, according to one embodiment herein, the heating module M1 may be capable of operating at pressures (Pcc) that is in the range from about 3-4 times greater than an ambient pressure up to in excess of 15 times or greater than ambient pressure. According to one embodiment, the ambient pressure may be atmospheric pressure. In accordance with another embodiment, however, the ambient pressure may be below or above atmospheric pressure. The gases from the heating module may have a temperature Tcc, measured at the exit of the heating module M1.

In one embodiment consistent with the present disclosure, the forming module M4 may have axial symmetry, e.g. having a circular cross section and having a throat diameter Dt and an expansion zone exit diameter De. In another embodiment the forming module M4 may be rectangular as illustrated by FIG. 2.

Consistent with the present disclosure, the heating module M1 may include any variety of apparatus capable of providing a gas stream having a pressure Pcc and temperature Tcc at the exit of the heating module M1. According to various embodiments, the heating module M1 may include combustion modules wherein the gas stream may include combustion gasses or products. Examples of combustion type heating modules may include oxygen-fuel combustion chambers, such as may be used with conventional high velocity oxygen-fuel thermal spraying apparatus. The heating module M1 may also include a resistance heating module capable of heating a gas introduced into the module. In other embodiments, the heating module M1 may include a plasma module.

According to one embodiment, the heating module M1 may be a plasma torch. Providing the heating module M1 configured as a plasma torch may provide various advantages arising from the wide range of available plasma enthalpies, temperatures, and velocities. However, plasma torches may experience erosion of electrodes which may shorten the operation time in between required servicing, and may in some condition result in contamination of the coating by erosion products. Erosion experienced by electrodes in a plasma torch may, at least in part, depend on plasma gases and their purity, plasma pressure and plasma current. Generally, higher plasma pressure and higher plasma current may increase the rate of erosion of the electrodes.

Despite erosion associated with relatively higher plasma pressure, high pressure plasma apparatus may be useful for providing a high pressure and high velocity apparatus suitable for use when ambient pressure is in the general range of atmospheric pressure. The useful life of the electrodes may be increased by decreasing the operating current of a high pressure plasma torch that may be suitable for use as an industrial tool operating in atmospheric or near atmospheric ambient pressure environments. For example, it may be desirable to employ an operating current at or below 400 A in a plasma torch having a 4-5 bars plasma pressure. It may be even more preferred to employ an operating current at or below 300 A for even higher pressure plasmas. Accordingly, plasma torches having minimum operating voltage above 125V are needed achieving 50 KW power level at 4-5 bars pressure. An operating voltage on the order of between about 180V to about 200V may be desirable for higher plasma pressures and/or higher power levels.

Consistent with the present disclosure, various different designs of high voltage plasma torches may be used as a heating module for a HVTS apparatus. For example, a 200 kW PlazJet™, manufactured by Praxair Technology, Inc., operating at approximately 400 volts may be used to provide up to about a 160 kW power level. Other suitable plasma devices may include, for example, a 100HE plasma torch, manufactured by Progressive Technologies, Inc., operating at approximately 200-230 volts may be used to provide up to about 80-90 kW power level.

A cascade plasma torch may provide an especially advantageous option for a plasma based heating module. A cascade plasma torch may generally include a cathode mounted in a cathode holder. An anode may be provided having a cylindrical shape, or may be provided having some means to stabilize the position of the anode arc root in order to minimize pulsation of plasma parameters, e.g., as may occur with a varying arc length. The means for stabilizing the position of the anode arc root may include a step. A cascade plasma torch design may be used for Low Pressure Plasma Spraying (LPPS).

One design consideration in providing a plasma torch suitable for use as a heating module of an HVTS apparatus herein is the configuration and design of the anode. The anode may be configured for different plasma passage geometries. According to one embodiment, the anode may act as an initial forming module for the plasma. However, as discussed above, the anode may be a subject of erosion which may cause the profile of the gas stream exiting the anode initial forming module to change over time. In order to minimize the problems associated with anode erosion, the forming module of the plasma apparatus, which may be connected with the mixing module, may be separated and electrically insulated from the anode. Separating the anode from the plasma forming module and electrically insulating the plasma forming module from the anode, may reduce or eliminate the influence of anode wear on the plasma forming module and plasma parameters. Notwithstanding the separation and electrical insulation of the forming module from the anode, it may still be desirable to stabilize the position of the anode arc root.

Generally, in providing a plasma torch there may be four general options for the anode configuration and/or forming module configuration. First, the anode may serve as the forming module of the plasma device. Second, the anode may have a means for stabilizing the arc root and the anode may serve as the forming module of the plasma device. According to one example, the arc root of the anode may be stabilized by a step. According to a third option, the anode and plasma forming module may be electrically insulated from one another. Finally, the anode and the plasma forming module may be electrically isolated, and the anode may include a means for arc stabilization.

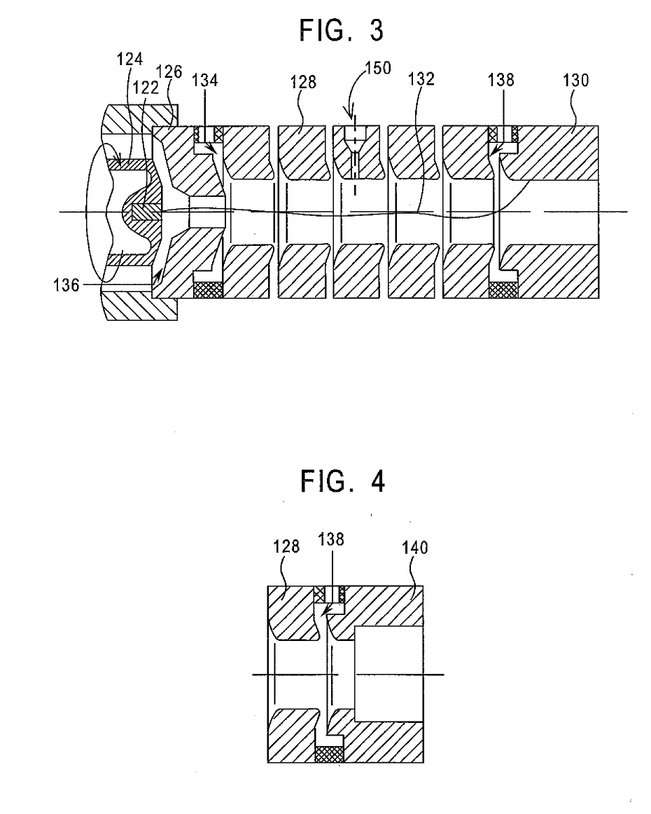

Consistent with the present disclosure, a plasma torch may be utilized as a heating module for a HVTS apparatus herein. The plasma torch may be configured as a cascade plasma torch that may provide a stable heating module and the ability to use a high-voltage, low current approach that may suitably be used with a wide range of plasma gas flow rates and related Reynolds's numbers. Such a cascade plasma gun may be capable of realizing laminar, transition, and turbulent plasma jet flows. The principles of a cascade plasma torch herein are schematically illustrated in FIG. 3, and described with reference thereto. As shown, an anode module 130 may be provided having a conventional cylindrical plasma passage. However, the anode module 130 may be configured having various different internal wall profiles, thereby allowing a stable position of the anode arc root and providing a plasma jet having different, controllable, temperatures and velocities. According to one embodiment, the anode module 130 may also serve as a forming module for the plasma torch. According to an alternative embodiment, the anode module 130 may include a means for stabilizing the position of an anode arc root and may be coupled, either directly or indirectly, to a separate forming module that may be electrically insulated from the anode module 130.

The embodiment of a cascade plasma torch illustrated in FIG. 3 includes cathode module including a cathode 122 mounted in a cathode holder 124. The plasma torch may also include an anode module 130, a pilot insert 126 and intermediate module having at least one interelectrode insert (IEI) 128 that is electrically insulated from cathode 122 and from the anode module 130. The interelectrode inserts 128 may generally be spacers that provide a desired separation between the anode and cathode, and may define the length of the plasma chamber. Accordingly, the number of IEI employed in a specific plasma torch may depend, at least in part, on the desired operating voltage and arc length. In the illustrated embodiment of FIG. 3, four IEI's are shown which may provide the plasma torch with an operating voltage in the general range of between about 150-250 V. A greater number of IEI may be required if a higher operating voltage is to be employed. The cascade plasma torch may also have a passage 150 that may be connected to a pressure sensor (not shown). The pressure sensor may be provided as part of a feedback circuit that may be used to control the pressure in the plasma channel.

It may be desirable to cool the various components of the plasma torch. Consistent with one embodiment, the various elements or modules of the plasma torch may be liquid cooled, e.g. water cooled. Accordingly, various elements or modules of the plasma torch may include cooling passages formed therein. Alternatively, cooling coils or coolant jacket may be provided around desired elements to be cooled.

Consistent with the illustrated embodiment, a first plasma gas may be supplied through a passage 136 and into a space between cathode 122/cathode holder 124 and the pilot insert 126. A second plasma gas may be supplied to the plasma channel through a passage 134. The flow rate of the second plasma gas may be greater than the flow rate of the first plasma gas. Consistent with one embodiment, under operating conditions, after the main arc has been initiated, the second flow rate may be around 5-10 times greater than the first flow rate. The first and second plasma gasses may be, for example, argon, hydrogen, nitrogen, air, helium or mixtures thereof. Other gases may also suitably be used.

Consistent with one embodiment, the first plasma gas may be argon. The argon first plasma gas may shield the cathode 122. Shielding the cathode 122 with the first plasma gas may extend the life of the cathode 122. Similarly, the anode 130 may be protected by anode shielding gas that may be supplied through a passage 138 adjacent the anode 130 and into anode plasma passage. The anode shielding gas may be, for example, argon or hydrocarbon gas like natural gas. According to one embodiment, the anode shielding gas may result in a diffusion of the anode arc root which, consequently, may increase life of the anode.

The cathode 122 may be connected to a negative terminal of a DC power source (not shown). During plasma ignition the positive terminal of the power source may be connected to the pilot insert 126. A high voltage, high frequency oscillator (not shown) may initiate a pilot electrical arc between the cathode 122 and the pilot insert 126. The DC power source may be employed to support the pilot arc. The pilot arc may ionize at least a portion of the gases in a passage between cathode 122 and anode 130. The pilot arc may then be expanded through the ionized plasma passage by switching the positive terminal of the DC power source from the pilot insert 126 to anode module 130. Expanding the pilot arc through the ionized plasma passage to the anode module may generate the main arc 132.

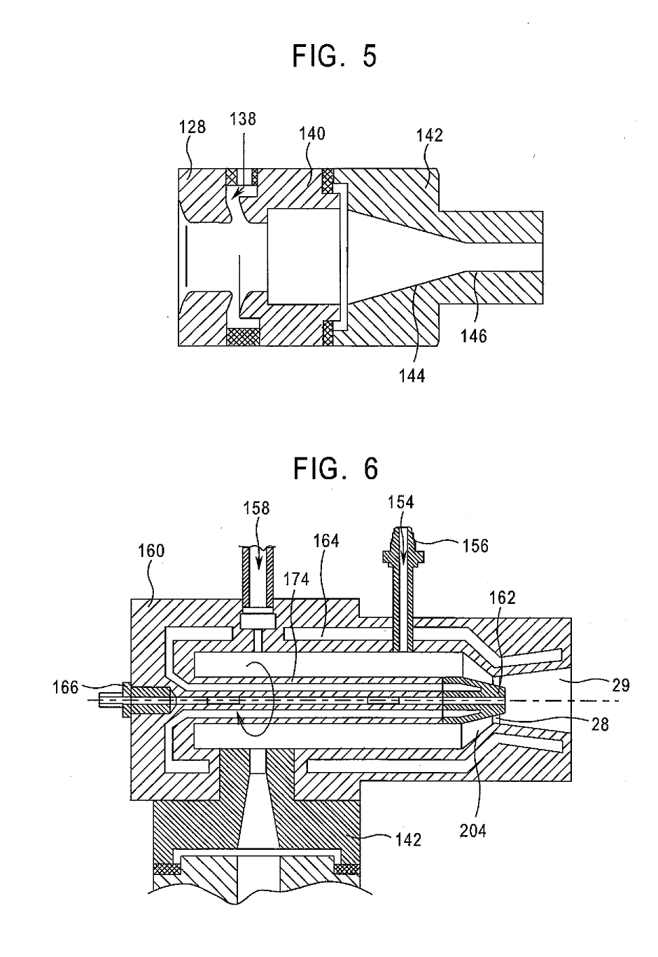

The anode module 130 may include a means for stabilizing the anode arc root position. Referring to FIG. 4 an embodiment of a “stepped” anode module 140 is illustrated. The stepped anode module 140 may act to stabilize the arc root position downstream of the step. That is, the stepped anode module 140 may limit the variation in the position where the arc contacts the anode. The anode may be provided having different profiles and may also serve as a forming module of the plasma device. Erosion of the anode, however, may result in changes of the dimensions of the anode plasma passage. Such changes in the dimensions of the anode plasma passage may result in related changes of the plasma parameters. According to an embodiment herein, a forming module of the plasma device may be provided that is electrically insulated from the anode. Electrically isolating the forming module from the anode may have an advantageous effect on the stability of parameters of a plasma jet exiting the forming module by reducing the impact of anode erosion on the dimensions of the plasma passage. One embodiment of an electrically insulated plasma forming module 142 coupled to a “stepped” anode 140 is illustrated by FIG. 5. According to one embodiment, the exit of the forming module 142 may be connected with a mixing module, discussed herein above.

FIGS. 6 through 8 illustrate various embodiments of an HVTS device including a mixing chamber 160. The mixing chamber 160 may be directly, or indirectly, coupled to an anode module 130 of a plasma torch, or to the initial plasma forming module 142 of a plasma torch including such an arrangement. Consistent with the illustrated embodiment, the mixing chamber 160 may include one or more passages 158 that may be coupled to a source of a pressurized gas at a predetermined temperature. According to one embodiment, the pressurized gas may be at a temperature less than the temperature of the gas entering the mixing chamber 160 from the plasma forming module 142. In one particular example, the pressurized gas may be at a temperature much less than the temperature of the gas entering the mixing chamber 160 from the plasma forming module 142. Suitable pressurized gases may include nitrogen, helium, argon, air and mixtures thereof, as well as various other gases. Such gasses when released from a pressurized state may naturally achieve a reduced temperature, thereby eliminating the need for any temperature conditioning apparatus. However, the use of temperature conditioning apparatus, either for cooling or heating the pressurized gas is contemplated herein.

As shown, the mixing chamber 160 may include at least one passage 154 that may be connected to a pressure sensor (not shown) which may be provided as part of a feedback circuit that may be used to control the pressure in the mixing chamber 160. A plasma jet may exit plasma channel 152 and may be mixed together with the pressurized gases supplied through the passages 158. Mixing of the gases may provide a desired temperature of gases exiting the mixing chamber 160. The mixture of gases may pass from the mixing chamber 160 into a converging zone 204, a throat 28 and an expansion zone 29 of a forming module. The forming module may accelerate the mixture of gasses up to a desired velocity. According to one embodiment, the forming module may accelerate the mixture of gases up to a supersonic velocity. The mixing chamber 160 may be water cooled using passages 164.

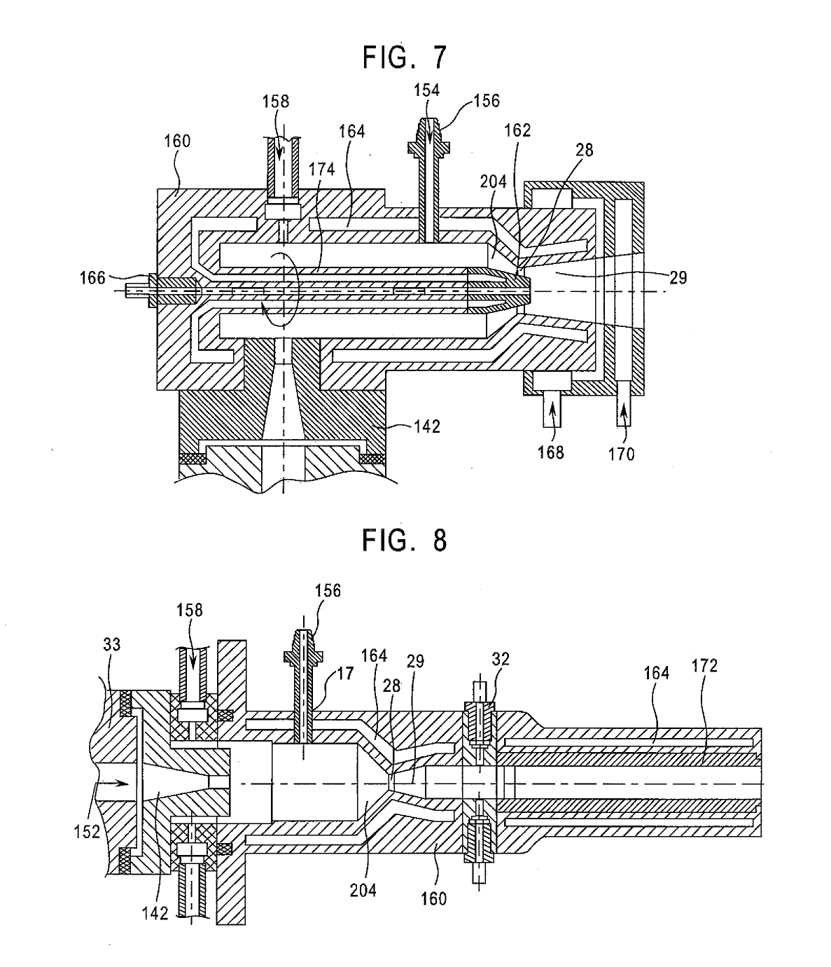

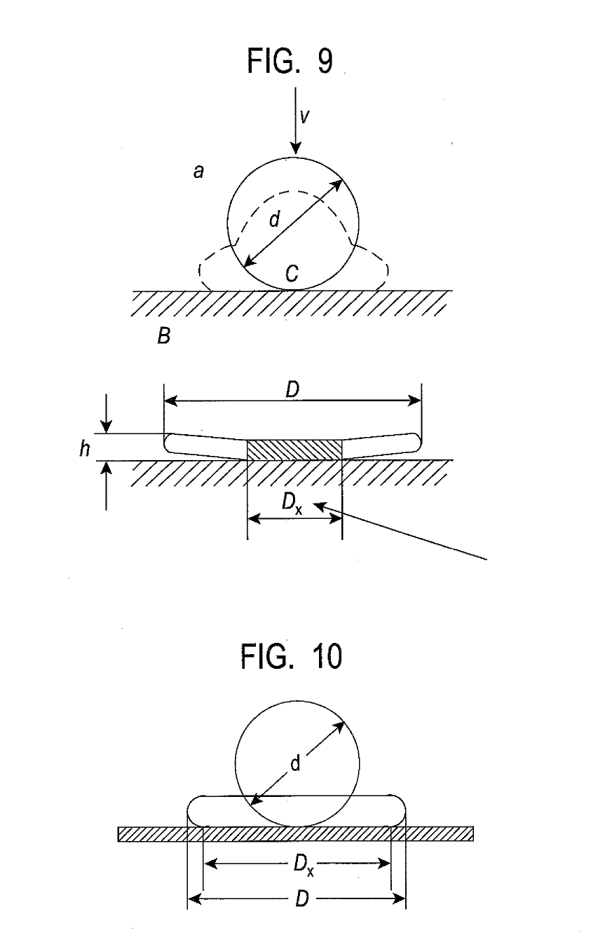

The embodiments illustrated in FIGS. 6 and 7 depict an axial powder feeding system. An axial powder feeding system may advantageously be used in combination with a right angle heating module, i.e., a heating module having a gas outlet oriented at an angle to the outlet of the mixing chamber 160. A modified configuration of the axial powder feeding system may also be used in connection with an embodiment in which the heating module is oriented axially with the outlet of the mixing chamber 160. FIGS. 6 and 7 illustrate an embodiment in which the mixing chamber 160 is connected with the plasma forming module 142 located generally 90 degrees relative to the axis of the mixing module 160.

Consistent with the illustrated axial powder feed system, a powder or particulate material may be fed through a fitting 166 into powder channel formed by a powder injector holder 174. Powder injector 162 is connected with the holder 174. The powder injector holder 174 as well as the powder injector 162 may be water cooled. The length of the powder injector holder 174 may be adjusted providing a desired position of the powder injector exit within the mixing chamber 160 or forming module. According to one embodiment, the exit of the powder injector 162 may be located inside the mixing chamber 160. In another embodiment the exit may be located in the converging zone 204 of the forming module. Furthermore, consistent with the illustrated embodiment, the exit of the powder injector 162 may be generally located in the throat 28 of the forming module. In still another embodiment the exit of the powder injector may be located in the expansion zone 29 of the forming module.

Turning to FIG. 7, an embodiment of a mixing chamber 160 and forming module arrangement is shown in which the expansion zone 29 of the forming module may be connected to a vacuum pump (not shown) through a passage 168. The vacuum pump may suck-up or remove the hot gases exiting the expansion zone 29, thus creating low pressure zone, increasing particle velocity and decreasing the likelihood of overheating of a substrate to be sprayed. Because spraying particles have a significantly higher inertia as compared with hot gases, the sprayed particles may not be sucked-up together with the hot gas. In another option the expansion zone 29 of the forming module may also have a passage 170, as depicted in FIG. 7, that may be connected with a source of a shielding gas. The application of shield gas may be carried out in combination with the use of the vacuum pump, and thereby may decrease the penetration of ambient air inside the forming module.

Referring next to FIG. 8, the expansion zone 29 of the forming module may be connected with a barrel. The barrel may serve to extend dwell time of particles introduced into the gas stream exiting the forming module. The increase in the dwell time of the particles may also provide an increase in the temperature and velocity of the particles as they exit the barrel. A powder feeding module (not shown) may be coupled to powder injectors, such as the radial powder injectors 32 of the embodiment shown in FIG. 8. The powder injectors 32 may feed powder into the gas stream from the mixing chamber 160 before the gas stream enters the barrel, as the gas stream is entering the barrel, or after the gas stream has entered the barrel. According to one embodiment, the powder injectors 32 may be located in a low pressure zone of the gas stream. Locating the powder injectors 32 in this manner may allow the use of a low pressure powder feeding module. Numerous other combinations of forming modules, barrels, etc. may be used in the context of the present disclosure.

According to one aspect, the present disclosure is directed at a method of forming a coating on a substrate. In general, the method consistent with the present disclosure may include feeding a powdered coating material (hereinafter “powder”) into a heated stream of gas or plasma. The heated stream of gas or plasma may be used to direct the powder at a substrate to be coated. The heated stream of gas or plasma may heat the particles of powder up to an average particle temperature Tp at the moment of collision with the substrate. Furthermore, the heated stream of gas or plasma may accelerate the particles of powder to an average particle velocity Vp at the moment of collision with the substrate. Upon collision with the substrate, the particles of powder may have a total specific energy Ep expressed by Equation (1) below.
Ep=CpTp+Vp²/2<Em (1)
where Em is a total specific energy needed to melt a particle; and Cp is the average thermal capacity of the particles of powder.

Collision between the particles of powder and the substrate may produce deformation and flattening of the particles δ that is greater than about 1.1, wherein δ=D/Dp, wherein D is an average size or diameter of the particle deformed by collision with the substrate (hereinafter “splats”) and Dp is an average size or diameter of sprayed particles prior to collision with the substrate.

A result of the condition Ep<Em, expressed by Equation (1), may be that a particle may not be molten upon colliding with the substrate. If the particle is not molten upon colliding with the substrate, the particle may not be splashed as a result of the collision. While the particle may not be molten upon colliding with the substrate, the particle temperature Tp at the moment of the impact may still be above the brittle-ductile transition temperature of the particle material. Providing the particle temperature Tp above the brittle-ductile transition temperature may avoid disintegration of spraying particles as a result of the collision between the particles and the substrate. A minimum value of Em (E_{m,min}) may be estimated according to Equation (2)
E_{m,min}=CpTm+Lm (2)
where Tm is the melting temperature or the powder; Cp is the average thermal capacity of the powder in the temperature range between room temperature and the melting temperature of the powder; Lm is the latent heat of melting of the powder.

During collision energy may be dissipated and heat transferred into the substrate. This energy dissipation and heat transfer may be characterized as energy losses ΔE. Therefore, particle total specific energy may be estimated according to Equation (3)
Ep<E_{m,min}+ΔE=CpTp+Vp²/2+ΔE (3)

Energy losses ΔE may depend on the powder and the material of the substrate. Accordingly, the energy loss ΔE may be determined experimentally in each particular case, i.e., for each given combination of powder and substrate materials.

Formation of a first layer of particles on a substrate may have requirements related to producing good bonding between particles of the powder and the substrate. It is believed that the bonding quality may depend on the density of dislocations. The deformed particles on the substrate have a high density of dislocation which may result from the collision with the substrate and consequent deformation. The high density of dislocation may provide good bonding between the particle and the substrate.

According to another aspect, a particle may need a balanced ratio between kinetic and potential or thermal energies to be properly deformed during a collision with a substrate. As a first component, the specific kinetic energy of particle having density p may increase the yield strength Yp(Tp) (at a low strain rate) of the particle material at the collision temperature Tp. This requirement was described, for example, in U.S. Pat. No. 6,743,468 B2. Desirably, the specific kinetic energy may increase the yield strength Yp(Tp) by a factor k>1 where k depends on requirements to a splat flattening as well as on the impact angle. This condition may be expressed according to Equation (4) below.
ρVₚ²/2>k*Yp(Tp) (4)

Although data related to yield strength at high temperatures is somewhat limited, it is believed that Vickers Hardness HV may be used as a technical measure of the yield stress that may be convenient in practical application. It has been shown that for metals and alloys the yield strength may correlate with the Vickers Hardness HV.

Furthermore, at high strain rates of around or above 10⁵ s⁻¹ deformation may result in viscous flow stresses which may be estimated as μ(Tp)|&|, where & is the effective strain rate; μ is the viscosity of solid material at high strain rate at temperature Tp. The strain rate during a plastic deformation of a particle may be estimated as Vp/Dp. For Vp=300 m/s and Dp=30 microns the strain rate is estimated as 10⁷ s⁻¹. Viscosity of a solid metal may be on the order of 10² Pa*s for Al and Al alloys; 10³-10⁴ Pa*s for Cu, Fe and Ni at room temperature. The viscosity may exponentially decrease with increasing particle temperature. Viscous flow stresses may have a significant input into a condition of particle deformation. Impact velocity Vp may be used for the initial estimates of the effective strain rate. Therefore, particle specific energy is a subject of the following condition
ρVₚ²/2>k*Yp(Tₚ)+μ(Tp)|&|˜k*Yp(Tp)+μ(Tp)Vp/Dp (5)

Equation (5) may allow the minimum velocity and temperature of particles able to form a coating in accordance with present disclosure to be estimated. While the high values of viscosity and strain rate exhibited by many metals at room temperatures may prevent the formation of a coating according to the present disclosure to be formed, it should be recognized that some heat may be generated in a particle during the initial shock wave phase of the particle's collision with a substrate. The heat generated in the particle may result in the particle temperature increasing by ΔT and this increase may be taken into account when calculating the specific energy of the particle according to Equation (5).

Referring to FIG. 10, during a collision between a substrate and a particle, a particle having a diameter d may form a splat which may be described as a pancake with and average size D in a plane parallel to the surface of the substrate at which the collision occurred. The splat may have an average thickness h in the plane perpendicular to the collided surface. The splat may exhibit good contact and bonding with the substrate because there is practically no splashing of the deformed particle and because the normal component of pressure may exist underneath of the entire splat. According to one embodiment, the level of flattening δ=D/Dp may be in the range of between about 1.05 to about 3. According to a particular embodiment, the level of flattening δ may be in the range of between about 1.1 to about 2.5. According to yet another embodiment, the level of flattening δ may be in the range of between about 1.5 and about 2. Consistent with some embodiments, desired levels of flattening 6 may be achieved when viscosity is of the particle at impact is approximately 10 Pa*s, or less, and the coefficient k is within or around approximately 2-4.

From the preceding, the requirements of temperature Tp and velocity Vp of the particles may be related to the material of the powder. Consistent with the present disclosure, general temperature Tp and velocity Vp requirements for three exemplary groups of powder material are discussed.

A first group of materials, Group 1, may include materials having a relatively low yield strength in the range of about 30-200 MPa at room temperature. Copper, nickel, aluminum, zinc and some other metals and alloys may be attributed to this group. For example copper has the following parameters: Yield strength is of about 70 MPa; Density is of about 8900 kg/m³; Viscosity is of about 10⁴ Pa*s. Copper powder having the foregoing physical properties may be coated on to a substrate at a velocity of about 500 m/s. At such a velocity, the specific kinetic energy may be estimated at approximately 1.1*10³ MPa. A particle having a diameter of about 30 microns coated on to a substrate at about 500 m/s may have a viscous flow stress estimated as approximately 160×10³ MPa. This viscous flow stress may significantly exceed the specific kinetic energy that violates the condition of Equation (5). In such a case, deposit efficiency may be expected to be negligibly small.

The viscosity of this first group of solid materials, however, rapidly decreases as their temperature increases. It may be expected that the viscosity of copper will decrease approximately by an order of magnitude for every 100 degrees C. in the range 20-500 C and may decreased down to about 10 Pa*s at a particle temperature of around 200-300 C. In this case, for coefficient k=2-3, particles accelerated up to a velocity in the range of about 550-700 m/s may be expected to form a coating with an acceptable deposit efficiency. This range of particle temperatures and velocities has been utilized during experiments carried out according to the present disclosure. Based on estimated characteristics according to the present disclosure, similar results may be expected for other materials from this group. Thus, Ni, Zn, Al and some other metals and alloys from this group may be sprayed with no or relatively low level of particles pre-heating, e.g. within the general range of between about 200-400 C.

A second group of materials consists of alloys having a high yield strength in the range of about 700-1200 MPa at room temperature. Some Ni, Fe and Co-based alloys, such as INCONEL 718 or MeCrAlY alloys, may be typical examples of members of this group. For the purpose of illustration, INCONEL 718 may exhibit a yield strength of approximately 1000 MPa and density of approximately 8200 kg/m³ within a range a range of 20-650 C. At a 1000 MPa yield stress and a coefficient k=2-3 a particle velocity in the range of about 700-850 m/s would be necessary to satisfy requirement expressed in Equation (4). Significantly higher velocity is needed to satisfy requirement expressed in Equation (5). Brittle disintegration of a particle accelerated to high velocities, for example, above 700 m/s, may be expected within the range of temperatures related to high yield stress of about 1000 MPa.

However, the yield stress of INCONEL 718 at temperatures above about 650 C decreases at the rate of approximately of factor 2 per 200 C. Thus, heating of a particle to a temperature of about 95° C. may result in the related yield stress of about 500 MPa. It may also be expected that a temperature of about 95° C. may be above the brittle-ductile transition and the viscosity of the material at 950 C may not be above bout 10 Pa*s. In this case, for the same coefficient k=2-3, a particle velocity in the range of about 550-700 m/s may be sufficient to achieve a coating in accordance with this disclosure.

A third group of materials may include ceramics and other materials having very high yield strength of above 1500 MPa at room temperature and a high temperature of brittle-ductile transition. It should be noted that the very high temperature of the brittle-ductile transition of these materials may make conventional combustion type spraying apparatus unsuitable for providing coatings of these materials. Alumina, having an estimated density of about 3960 kg/m³ and an estimated yield strength of about 3000 MPa at room temperature, and of about 1900 MPa at 1000 C, may be considered as a typical member of this group. The yield strength is believed to decrease at temperatures above 1000 C approximately by a factor of 2 per every about 200 C. The melting temperature of alumina may be estimated at about 2054 C. A temperature of a brittle-ductile transition for this group of materials may be expected within 0.6-0.8 Tm, where Tm is measured in Kelvin scale and the transition temperature depends on the alumina grain size and some other factors. For the brittle-ductile transition of about 1350 C (approximately corresponding to 0.7 Tm) the yield strength at this temperature may be estimated of about 540 MPa and the viscosity may be expected below 10 Pa*s. Under such conditions, the particles require a collision velocity Vp in the range of about 700-850 m/s in order to form a coating according to the present disclosure. These very high velocities may not be economical in some cases because of the high pressure and related high flow rates of accelerating gases needed to achieve such velocities. The required velocities may be decreased, however, if the particle temperature is increased. For example, alumina particles heated to a temperature of about 1500 C may only require a particle velocity of about 600-700 m/s to form a high quality coating.

In each of the preceding examples, it should be noted that the conditions of Equations (2) and (3) were satisfied.

The spayed particles may be provided having different sizes or diameters which may be characterized by the size distribution with the related average particle size Dpₐᵥ and standard deviation σ. Particles of different sizes may have different masses, assuming the same material. The particles of differing sizes may, therefore, also have different temperatures and velocities as sprayed onto a substrate under the same condition. In addition to the variation in particle size, a gas stream employed to spay a substrate may present a gradient of conditions across the profile of the stream. For example, there may be a gradient of the gas or plasma parameters across the forming module and barrel of an HVTS apparatus described herein. The gradient may also result in different temperature and velocity characteristics of particles having the same mass or size depending upon the location of the particles within the gas stream.

For example, if a relatively large particle is determined to have a desired temperature and/or velocity for spray coating a substrate, then it may be expected that a relatively smaller particle may have a higher temperature and/or velocity than desired. The variation in heating and/or velocity characteristics of particles of different sizes or masses may produce a variation in deformation and flattening characteristics when the particles collide with a substrate.

According to a related aspect, desired parameters may be provided for particles with size of about Dpₐᵥ. According to such an embodiment, the temperature and the velocity of smaller particles may only differ slightly from the desired parameters and still provide a good coating. However, particles having a size larger than dav may exhibit a lower temperature and/or velocity compared to the desired parameters. In some cases the lower temperature and/or lower velocity exhibited by the relatively larger particles may prevent the larger particles from forming a coating. In some cases, the larger particles may bounce off of the substrate or the previously applied coating after colliding with the substrate as they don't have enough energy to satisfied requirement (5). While the larger particles may not form a coating on the substrate, the collision of the larger particles against the substrate and/or previously applied coating may provide a shot peening effect to the previously sprayed particles. Shot peening may control stresses of a coating and also result in densification of the coating. Thus, shot peening may be desirable when very high quality coating is desired.

Based on this effect, the present disclosure may provide a method to allow simultaneous spray coating and shot peening in order to develop neutral or compressive stresses in the coating as well as to increase the density of the coating. Simultaneous shot peening may be accomplished using the same material that is sprayed to produce the coating. In one embodiment, powder material sprayed to form the coating may include coating particles having a first average size and peening particles having a second, larger, size. The greater mass of the peening particles may result in a lower particle velocity and lower particle temperature than required to form a coating. Rather than impacting the substrate or previous coating layer and adhering to thereto, the larger particles may instead strike the substrate or previously applied coating layer imparting a compressive stress. After striking the substrate or previously applied coating layer, the larger particles may bounce or fall away from the substrate. Accordingly, the peening particle need not impede subsequent coating of the substrate.

While the peening particles may be provided of the same material as the coating particles, according to an alternative embodiment the shot peening particles may be provided from a different material. Consistent with this aspect it is not necessary for the shot peening particles to have a larger size than the coating particles. For example, the shot peening particles may be provided from a material having a higher yield strength and melting point than the coating material. According, the shot peening particles may not have sufficient combinations of conditions to forming a coating. However, the shot peening particles may additionally, be provided having a size that is different than the coating particles. Consistent with any of the preceding embodiments providing simultaneous shot peening, the shot peening particles, or media, may be introduced into the gas stream in a mixture with the coating particles. For example, the coating particles and shot peening media may be pre-mixed and introduced into the gas stream together with the coating particles.

According to a related embodiment, the simultaneous shot peening may be carried out using a shot peening media which may be introduced into the gas stream via a different injector or port than the coating particles. In still another embodiment, simultaneous shot peening may involve a separate stream of gas for applying the coating material and for shot peening the substrate and/or previously applied coating. The separate gas streams, in such an embodiment, may be provided by a single apparatus or by two apparatus used in combination with one another.

What is claimed is:

1. A method of supplying a coating to a substrate via the use of particles, said method comprising heating and accelerating the particles under the following conditions:
Ep<E_{melting}, (i)
where Ep represents the total kinetic and thermal energy of the particle, and E_{melting} represents the amount of energy necessary to melt the particle;
E_{kinetic}>[K]Y[Tp]+μVp/Dp, (ii)
wherein E_{kinetic} is the kinetic energy of the particle, Y[Tp] is the yield stress of the particle when the particle is at a selected temperature [Tp], and [K] is number greater or than 1, and Dp is the particle diameter, and p is viscosity of the particle when the particle is at selected temperature [Tp].

2. The method of claim 1, further including the condition that the particle, upon impact, observes the following relationship:
Do/Dp>1
where Do is the diameter of the particle after impact and Dp is the particle diameter prior to impact.

3. The method of claim 2, wherein Do/Dp is ≦2.5.

4. The method of claim 1 wherein K has a value of about 1.1-4.0.

5. The method of claim 1 where K have a value of about 2.0-3.0.

6. A coating prepared according to the method of claim 1.

7. The method of claim 1 wherein selected temperature [Tp] is above the brittle-ductile transformation of said particle.

8. A method of supplying a coating to a substrate via the use of particles, said method comprising heating and accelerating the particles under the following conditions:
(i) ascertain the value E_{melting} for the particle
where E_{melting} represents the amount of energy necessary to melt said particle; and
(ii) establishing a particle velocity and temperature for spraying such that
Ep<E_{melting}, (a)
where Ep represents the total kinetic and thermal energy, and E_{melting} represents the amount of energy necessary to melt the particle; and
E_{kinetic}>[K]Y[Tp]+μVp/Dp, (b)
wherein E_{kinetic} is the kinetic energy of the particle, Y[Tp] is the yield stress of the particle when the particle is at a selected temperature [Tp], and [K] is number greater or than 1, and Dp is the particle diameter, and p is viscosity of the particles when the particles is at selected temperature [Tp].

9. A method according to claim 8 wherein said selected temperature [Tp] is above the brittle-ductile transformation of said particle.

10. A method in accordance to claim 1 including the additional step of impinging the formed coating with additional particles to provide a shot peening effect.

11. A method in accordance to claim 10 wherein particles employed for shot peening are of the same material as spraying particles.

12. A method of claim 10 wherein said coating particles have a melting point and yield stress and said particles used for shot peening have either a higher melting point or higher yield stress.

13. A thermal spay apparatus capable of supplying a coating to a substrate via the use of particles, said apparatus heating and accelerating the particles under the following conditions:
Ep<E_{melting}, (i)
where Ep represents the total kinetic and thermal energy of the particle, and E_{melting} represents the amount of energy necessary to melt the particle;
E_{kinetic}>[K]Y[Tp]+μVp/Dp, (ii)
wherein E_{kinetic} is the kinetic energy of the particle, Y[Tp] is the yield stress of the particle when the particle is at a selected temperature [Tp], and [K] is number greater or than 1, and Dp is the particle diameter, and p is viscosity of the particle when the particle is at selected temperature [Tp].

14. The apparatus of claim 13 wherein said apparatus comprises:
a heating module heating pressurized gases having pressure “P”,
a forming module coupled to a stream of gas generating by said heating module, said forming module comprising a subsonic zone having an entrance coupled with the heating module and an exit, a throat having a constant cross-sectional area coupled to said exit of said subsonic zone, and a supersonic zone having an entrance coupled with the throat and an exit;
and a powder injection module consisting from at least one powder injector and introducing powder material into said stream of gas.

15. A thermal spray apparatus in accordance to claim 14 wherein said apparatus contains a mixing module to combine high temperature gas generated by the heating module with lower temperature compressed gas.

16. A thermal spray apparatus in accordance to claim 14 containing a barrel coupled to said forming module.

17. A thermal spray apparatus in accordance to claim 14 wherein “P” is a pressure at least about four times greater than ambient pressure.

18. A thermal spray apparatus in accordance to claim 17 wherein said ambient pressure is about atmospheric pressure.

19. A thermal spray apparatus in accordance to claim 17 wherein said ambient pressure is lower than atmospheric pressure.

20. A thermal spray apparatus according to claim 14, wherein said heating module comprises a combustion module.

21. A thermal spray apparatus according to claim 14, wherein said heating module comprises a plasma torch.

22. A thermal spray apparatus according to claim 14, wherein said heating module comprises a resistive heating module.
